(19) United States
(12) Patent Application Publication
(10) Pub. No.: US 2025/0151158 A1
(43) Pub. Date: May 8, 2025

(54) METHOD, DEVICE, AND SYSTEM FOR DISCONTINUOUS DATA TRANSMISSION AND RECEPTION IN WIRELESS NETWORKS

(71) Applicant: ZTE Corporation, Shenzhen (CN)

(72) Inventors: Xiubin SHA, Shenzhen (CN); Bo DAI, Shenzhen (CN); Yuan GAO, Shenzhen (CN); Eswar Kalyan VUTUKURI, Havant (GB)

(73) Assignee: ZTE Corporation, Shenzhen, GD (CN)

(21) Appl. No.: 19/012,045

(22) Filed: Jan. 7, 2025

Related U.S. Application Data
(63) Continuation of application No. PCT/CN2023/085602, filed on Mar. 31, 2023.

(51) Int. Cl. H04W 76/28

(52) U.S. Cl. CPC H04W 76/28

(57) ABSTRACT

This disclosure relates generally to a method, device, and system for discontinuous data transmission and discontinuous data reception in a wireless network. One method performed by a wireless device is disclosed. The method may include receiving, from a network node, a first message comprising a first connected state Discontinuous Reception (DRX) configuration or an indicator indicating the first connected state DRX configuration, wherein the first connected state DRX configuration is assigned to a first target associated with a first service of the wireless device, the first target comprising one of following: a Data Radio Bearer (DRB); a logical channel; a Semi-Persistent Scheduling (SPS); a Configured Grant (CG); or a Hybrid Automatic Repeat Request (HARQ) process; and applying the first connected state DRX configuration to the first target.

### TECHNICAL FIELD

This disclosure is directed generally to wireless communications, and particularly to a method, device, and system for discontinuous data transmission and discontinuous data reception in a wireless network.

### BACKGROUND

Controlling power consumption and reducing energy cost is critical for developing and deploying a wireless communication network. Energy saving technology is critical for achieving this goal. With the development of wireless communication technology, more and more services, applications, as well as various power saving mechanisms are added which increases the complexity for power control. It is critical to have the capability to control the power consumption for various network elements, such as base station and UE, and yet still meet performance requirement.

### SUMMARY

This disclosure is directed to a method, device, and system for discontinuous data transmission and discontinuous data reception in a wireless network.

In some embodiments, a method performed by a wireless device is disclosed. The method may include: receiving, from a network node, a first message comprising a first connected state Discontinuous Reception (DRX) configuration or an indicator indicating the first connected state DRX configuration, wherein the first connected state DRX configuration is assigned to a first target associated with a first service of the wireless device, the first target comprising one of following: a Data Radio Bearer (DRB); a logical channel; a Semi-Request (HARQ) process; and applying the first connected state DRX configuration to the first target.

In some embodiments, a method performed by a wireless device is disclosed. The method may include: transmitting, to a network node, an indicator indicating a radio capability of the wireless device, the radio capability being indicative of whether the wireless device support a HARQ mode B when a serving cell of the wireless device is a terrestrial network cell, wherein in the HARQ mode B, a HARQ Round Trip Time (RTT) timer and a HARQ retransmission timer are not started; and receiving, from the network node when the wireless device is in the terrestrial network cell, a HARQ mode indicator indicating the wireless device to apply the HARQ mode B.

In some embodiments, a method performed by a wireless device is disclosed. The method may include: receiving, from a network node, a first message indicating deactivating a DRX HARQ Round Trip Time timer (drx-HARQ-RTT-Timer), the drx-HARQ-RTT-Timer applying to a target comprising one of following: a Data Radio Bearer (DRB); a logical channel; a Semi-Persistent Scheduling (SPS); a Configured Grant (CG); or a Hybrid Automatic Repeat Request (HARQ) process.

In some embodiments, a method performed by a wireless device is disclosed. The method may include: receiving, via a UE specific message targeting the wireless device, an indicator indicating whether a cell discontinuous operation is activated in a cell, wherein the cell discontinuous operation comprising at least one of a cell Discontinuous Transmission (DTX) or a cell Discontinuous Reception (DRX); and in response to the indicator indicating the cell discontinuous operation being activated in the cell, activating a configuration associated with the cell discontinuous operation.

In some embodiments, a method performed by a network node is disclosed. The method may include: transmitting, to a wireless device, a first message comprising a first connected state Discontinuous Reception (DRX) configuration or an indicator indicating the first connected state DRX configuration, wherein the first connected state DRX configuration is assigned to a first target associated with a first service of the wireless device, the first target comprising one of following: a Data Radio Bearer (DRB); a logical channel; a Semi-Request (HARQ) process.

In some embodiments, a method performed by a network node is disclosed. The method may include: receiving, from a wireless device, an indicator indicating a radio capability of the wireless device, the radio capability being indicative of whether the wireless device support a HARQ mode B when a serving cell of the wireless device is a terrestrial network cell, wherein in the HARQ mode B, a HARQ Round Trip Time (RTT) timer and a HARQ retransmission timer is not started; and transmitting, to the wireless device served by the terrestrial network cell, a HARQ mode indicator indicating the wireless device to apply the HARQ mode B

In some embodiments, a method performed by a network node is disclosed. The method may include: transmitting, to a wireless device, a first message indicating the wireless device to deactivate a DRX HARQ Round Trip Time timer (drx-HARQ-RTT-Timer), wherein the drx-HARQ-RTT-Timer applies to a target for the wireless device and the target comprises one of following: a Data Radio Bearer (DRB); a logical channel; a Semi-Persistent Scheduling (SPS); a Configured Grant (CG); or a Hybrid Automatic Repeat Request (HARQ) process.

In some embodiments, a method performed by a network node is disclosed. The method may include: transmitting, via a UE specific message targeting a wireless device, an indicator indicating whether a cell discontinuous operation is activated in a cell of the network node, wherein the cell discontinuous operation comprising at least one of a cell Discontinuous Transmission (DTX) or a cell Discontinuous Reception (DRX).

In some embodiments, there is a wireless device or a network node comprising a processor and a memory, wherein the processor is configured to read code from the memory and implement any methods recited in any of the embodiments.

In some embodiments, a computer program product comprising a computer-readable program medium code stored thereupon, the code, when executed by a processor, causing the processor to implement any method recited in any of the embodiments.

The above embodiments and other aspects and alternatives of their implementations are described in greater detail in the drawings, the descriptions, and the claims below.

### BRIEF DESCRIPTION OF THE DRAWINGS

FIG. 1 shows an example wireless communication network.

FIG. 2 shows an example wireless network node.

FIG. 3 shows an example user equipment.

FIGS. 4a-4c show exemplary resource (DRB, LC, SPS, CG) to HARQ process mappings.

FIG. 5 shows a common (fits all) connected state DRX configuration applies to all HARQ service under a cell, or a DRB group.

FIGS. 6a-6f show exemplary connected state DRX configurations specific to or targets a resource or a HARQ process.

FIG. 7 shows an exemplary message flow for configuring connected state DRX configuration for a specific service of a UE.

FIG. 8 shows an exemplary message flow for configuring a HARQ mode for a UE, according to UE capability with respect to the support of HARQ mode mechanism in TN network.

FIG. 9 shows scenarios in which UE miss cell DTX and/or cell DRX activation.

FIG. 10 shows exemplary message flow for activating cell DTX and/or cell DRX in event of UE handover or UE RRC connection setup.

FIG. 11 shows example combined cell DTX and cell DRX configurations sent to UE, with cell DTX and/or cell DRX activation indicator.

FIG. 12 shows another example separate cell DTX configurations and cell DRX configurations sent to UE, with cell DTX and/or cell DRX activation indicator.

### DETAILED DESCRIPTION

### Wireless Communication Network

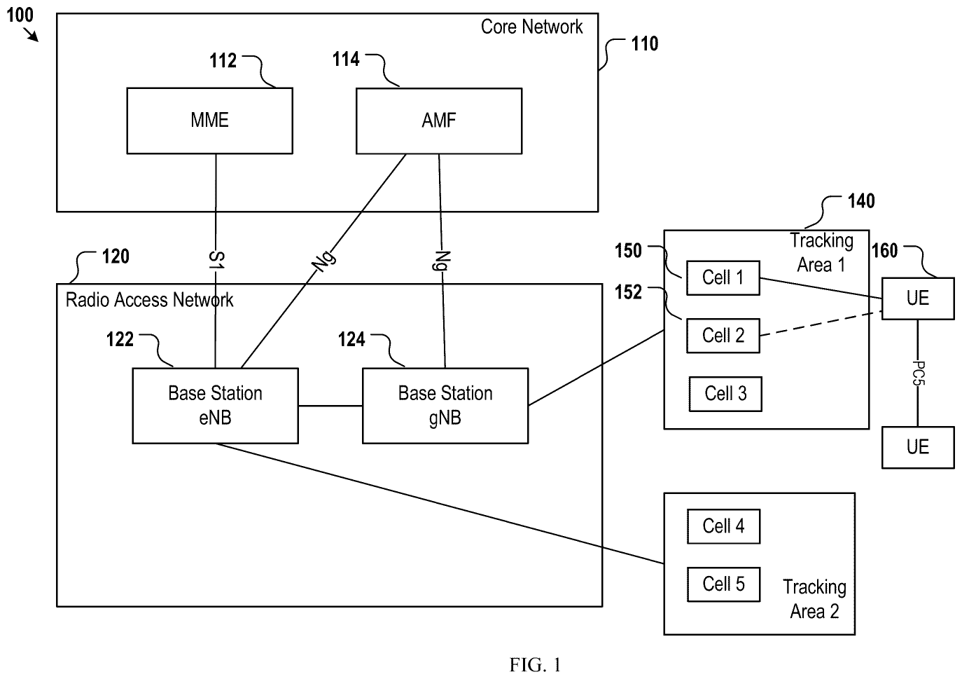

FIG. 1 shows an exemplary wireless communication network 100 that includes a core network 110 and a radio access network (RAN) 120. The core network 110 further includes at least one Mobility Management Entity (MME) 112 and/or at least one Access and Mobility Management Function (AMF). Other functions that may be included in the core network 110 are not shown in FIG. 1. The RAN 120 further includes multiple base stations, for example, base stations 122 and 124. The base stations may include at least one evolved NodeB (eNB) for 4G LTE, an enhanced LTE eNB (ng-eNB), or a Next generation NodeB (gNB) for 5G New Radio (NR), or any other type of signal transmitting/receiving device such as a UMTS NodeB. The eNB 122 communicates with the MME 112 via an SI interface. Both the eNB 122 and gNB 124 may connect to the AMF 114 via an Ng interface. Each base station manages and supports at least one cell. For example, the base station gNB 124 may be configured to manage and support cell 1, cell 2, and cell 3.

The gNB 124 may include a central unit (CU) and at least one distributed unit (DU). The CU and the DU may be co-located in a same location, or they may be split in different locations. The CU and the DU may be connected via an F1 interface. Alternatively, for an eNB which is capable of connecting to the 5G network, it may also be similarly divided into a CU and at least one DU, referred to as ng-eNB-CU and ng-eNB-DU, respectively. The ng-eNB-CU and the ng-eNB-DU may be connected via a W1 interface.

The wireless communication network 100 may include one or more tracking areas. A tracking area may include a set of cells managed by at least one base station. For example, tracking area 1 labeled as 140 includes cell 1, cell 2, and cell 3, and may further include more cells that may be managed by other base stations and not shown in FIG. 1. The wireless communication network 100 may also include at least one UE 160. The UE may select a cell among multiple cells supported by a base station to communication with the base station through Over the Air (OTA) radio communication interfaces and resources, and when the UE 160 travels in the wireless communication network 100, it may reselect a cell for communications. For example, the UE 160 may initially select cell 1 to communicate with base station 124, and it may then reselect cell 2 at certain later time point. The cell selection or reselection by the UE 160 may be based on wireless signal strength/quality in the various cells and other factors.

The wireless communication network 100 may be implemented as, for example, a 2G, 3G, 4G/LTE, or 5G cellular communication network. Correspondingly, the base stations 122 and 124 may be implemented as a 2G base station, a 3G NodeB, an LTE eNB, or a 5G NR gNB. The UE 160 may be implemented as mobile or fixed communication devices which are capable of accessing the wireless communication network 100. The UE 160 may include but is not limited to mobile phones, laptop computers, tablets, personal digital assistants, wearable devices, Internet of Things (IoT) devices, MTC/eMTC devices, distributed remote sensor devices, roadside assistant equipment, XR devices, and desktop computers. The UE 160 may also be generally referred to as a wireless communication device, or a wireless terminal. The UE 160 may support sidelink communication to another UE via a PC5 interface.

While the description below focuses on cellular wireless communication systems as shown in FIG. 1, the underlying principles are applicable to other types of wireless communication systems for paging wireless devices. These other wireless systems may include but are not limited to Wi-Fi, Bluetooth, ZigBee, and WiMax networks.

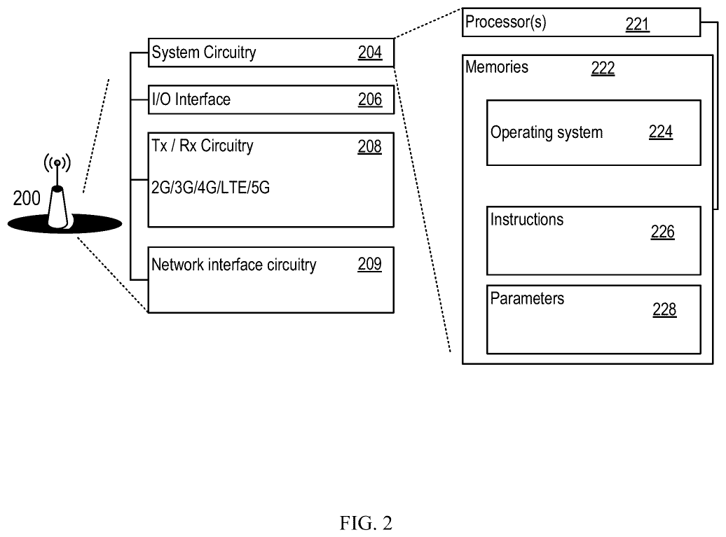

FIG. 2 shows an example of electronic device 200 to implement a network base station (e.g., a radio access network node), a core network (CN), and/or an operation and maintenance (OAM). Optionally in one implementation, the example electronic device 200 may include radio transmitting/receiving (Tx/Rx) circuitry 208 to transmit/receive communication with UEs and/or other base stations. Optionally in one implementation, the electronic device 200 may also include network interface circuitry 209 to communicate the base station with other base stations and/or a core network, e.g., optical or wireline interconnects, Ethernet, and/or other data transmission mediums/protocols. The electronic device 200 may optionally include an input/output (I/O) interface 206 to communicate with an operator or the like.

The electronic device 200 may also include system circuitry 204. System circuitry 204 may include processor(s) 221 and/or memory 222. Memory 222 may include an operating system 224, instructions 226, and parameters 228. Instructions 226 may be configured for the one or more of the processors 221 to perform the functions of the network node. The parameters 228 may include parameters to support execution of the instructions 226. For example, parameters may include network protocol settings, bandwidth parameters, radio frequency mapping assignments, and/or other parameters.

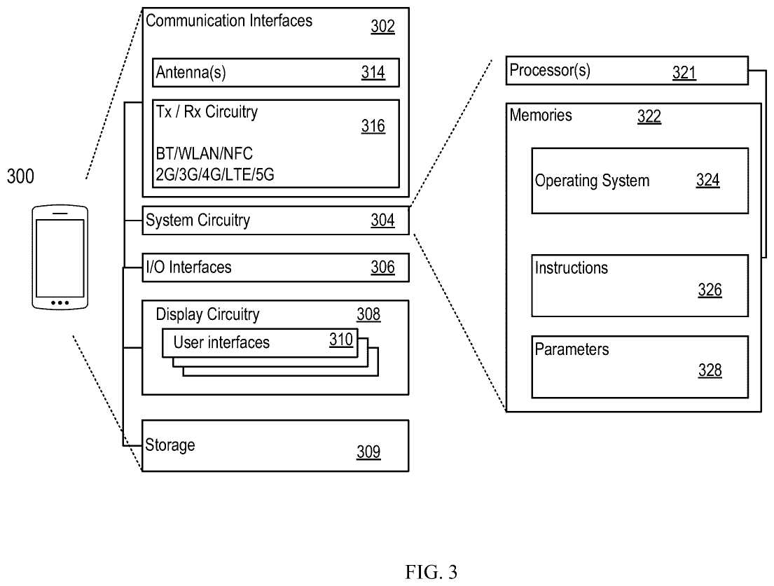

FIG. 3 shows an example of an electronic device to implement a terminal device 300 (for example, a user equipment (UE)). The UE 300 may be a mobile device, for example, a smart phone or a mobile communication module disposed in a vehicle. The UE 300 may include a portion or all of the following: communication interfaces 302, a system circuitry 304, an input/output interfaces (I/O) 306, a display circuitry 308, and a storage 309. The display circuitry may include a user interface 310. The system circuitry 304 may include any combination of hardware, software, firmware, or other logic/circuitry. The system circuitry 304 may be implemented, for example, with one or more systems on a chip (SoC), application specific integrated circuits (ASIC), discrete analog and digital circuits, and other circuitry. The system circuitry 304 may be a part of the implementation of any desired functionality in the UE 300. In that regard, the system circuitry 304 may include logic that facilitates, as examples, decoding and playing music and video, e.g., MP3, MP4, MPEG, AVI, FLAC, AC3, or WAV decoding and playback; running applications; accepting user inputs; saving and retrieving application data; establishing, maintaining, and terminating cellular phone calls or data connections for, as one example, internet connectivity; establishing, maintaining, and terminating wireless network connections, Bluetooth connections, or other connections; and displaying relevant information on the user interface 310. The user interface 310 and the inputs/output (I/O) interfaces 306 may include a graphical user interface, touch sensitive display, haptic feedback or other haptic output, voice or facial recognition inputs, buttons, switches, speakers and other user interface elements. Additional examples of the I/O interfaces 306 may include microphones, video and still image cameras, temperature sensors, vibration sensors, rotation and orientation sensors, headset and microphone input/output jacks, Universal Serial Bus (USB) connectors, memory card slots, radiation sensors (e.g., IR sensors), and other types of inputs.

Referring to FIG. 3, the communication interfaces 302 may include a Radio Frequency (RF) transmit (Tx) and receive (Rx) circuitry 316 which handles transmission and reception of signals through one or more antennas 314. The communication interface 302 may include one or more transceivers. The transceivers may be wireless transceivers that include modulation/demodulation circuitry, digital to analog converters (DACs), shaping tables, analog to digital converters (ADCs), filters, waveform shapers, filters, pre-amplifiers, power amplifiers and/or other logic for transmitting and receiving through one or more antennas, or (for some devices) through a physical (e.g., wireline) medium. The transmitted and received signals may adhere to any of a diverse array of formats, protocols, modulations (e.g., QPSK, 16-QAM, 64-QAM, or 256-QAM), frequency channels, bit rates, and encodings. As one specific example, the communication interfaces 302 may include transceivers that support transmission and reception under the 2G, 3G, BT, WiFi, Universal Mobile Telecommunications System (UMTS), High Speed Packet Access (HSPA)+, 4G/Long Term Evolution (LTE), and 5G standards. The techniques described below, however, are applicable to other wireless communications technologies whether arising from the 3rd Generation Partnership Project (3GPP), GSM Association, 3GPP2, IEEE, or other partnerships or standards bodies.

Referring to FIG. 3, the system circuitry 304 may include one or more processors 321 and memories 322. The memory 322 stores, for example, an operating system 324, instructions 326, and parameters 328. The processor 321 is configured to execute the instructions 326 to carry out desired functionality for the UE 300. The parameters 328 may provide and specify configuration and operating options for the instructions 326. The memory 322 may also store any BT, WiFi, 3G, 4G, 5G or other data that the UE 300 will send, or has received, through the communication interfaces 302. In various implementations, a system power for the UE 300 may be supplied by a power storage device, such as a battery or a transformer.

### Connected State Discontinuous Reception (CDRX)

In a wireless communication network, a UE may always listen/monitor the network (e.g., a base station) to check if there is new downlink data. The UE may also need to wait for uplink grant for transmitting uplink data. A notification for scheduled downlink data or uplink transmission grant may arrive through Physical Downlink Control Channel (PDCCH) that the UE needs to monitor. To always listen/monitor the network is not power efficient and would quickly drain the battery of the UE. For example, if the traffic for the UE is light or there no traffic at all, even there is no downlink reception or uplink transmission for the UE, for example, for one or more subframes, the UE still needs to keep awake to monitor the PDCCH. In order to reduce UE power consumption, a Connected state (or mode) Discontinuous Reception (CDRX) feature is introduced. When CDRX is configured for the UE in connected state, each CDRX cycle may include one “ON” period and one “OFF” period. The UE does not have to continuously monitor the PDCCH, but only monitors the PDCCH during the “ON” period, and switches to sleep mode during the “OFF” period. In the sleep mode, the UE may turn off certain hardware circuitries, such as Radio Frequency (RF) chain, to reduce power consumption.

In example implementations, the UE may be configured with a set of CDRX parameters (e.g., by the base station). These CDRX parameters may be selected based on, for example, service or application type such that power and resource savings are maximized, yet a Quality of Service (QOS) requirement is still met for the service or the application. Note that the CDRX parameters may impact service performance matrix, such as latency.

For example, there might be a delay in receiving data as the UE may be in OFF period at the time of data arrival at the base station (such as a gNB), and the base station would have to wait until the UE enters ON state. Therefore, the CDRX parameters may need to be carefully selected to find a balance between power saving and its impact on QoS.

### Cell Discontinuous Transmission (DTX) and Cell Discontinous Reception (DRX)

In order to further reduce the energy consumption of a base station such as a gNB, a base station side Discontinuous Transmission (DTX) mode may be implemented. The base station side DTX mode may apply to various levels, such as a cell level, a cell group level, a DU level, a DU group level, or a whole base station level. Using cell as an example, when the DTX mode is applied to the cell, the cell may be configured with a cell DTX cycle. Within each cell DTX cycle, there may be an “ON” period an “OFF” period. The cell may only transmit downlink data to its served UEs during the “ON” period, and suspend data transmission during the “OFF” period, to reduce power consumption. In some embodiment, during the cell DTX “OFF” period, a downlink signal or a downlink channel is disabled, that is, the cell does not transmit a downlink signal or channel during cell DTX OFF period. Meanwhile, the UE does not receive the downlink signal or channel during cell DTX OFF period. For example, UE does not monitor PDCCH and PDSCH over SPS (Semi-Persistent Scheduling) during cell DTX OFF period.

The similar concept may also apply to data reception at a base station. A base station side Discontinuous Reception (DRX) mode may be implemented. The base station side DRX mode may similarly apply to various levels, such as a cell level, a cell group level, a DU level, a DU group level, or a whole base station level. Using cell as an example, when the DRX mode is applied to the cell, the cell may be configured with a cell DRX cycle. Within each cell DRX cycle, there may be an “ON” period an “OFF” period. The cell may only receive uplink data to from UEs during the “ON” period, and suspend data reception during the OFF period, to further reduce power consumption. In some embodiment, during the cell DRX OFF period, the uplink signal or the uplink channel is disabled, that is, the UE does not transmit a uplink signal or channel during the cell DRX OFF period, and the cell does not receive the uplink signal or channel during cell DRX OFF period. For example, UE does not transmit PUSCH over CG (Configured Grant) during cell DRX OFF period.

The above description uses cell as example. The same underlying concept may apply to a cell group, a DU, a DU group, and a base station.

In this disclosure, various embodiments are disclosed, aiming for reducing power consumption at a base station and a UE. These embodiments cover at least:
Configuring CDRX parameters at a finer level: CDRX configuration per DRB, per logical channel, per Semi-Persistent Scheduling (SPS), per Configured Grant (CG), or per Hybrid Automatic Repeat reQuest (HARQ) process.
Configuring HARQ mode for a UE in Terrestrial Network (TN).
Deactivating HARQ timer with a finer level: per DRB, per logical channel, per Semi-Persistent Scheduling (SPS), per Configured Grant (CG), or per Hybrid Automatic Repeat reQuest (HARQ) process.
Cell DTX and/or cell DRX activation indication.

Details on these embodiments are described below.

### Embodiment 1: CDRX Configuration Parameters Configured Per Service

In a wireless network, a UE may support various types of services, for example, enhanced Mobile Broadband (eMBB), Ultra Reliable Low Latency Communications (URLLC), massive Machine Type Communications (mMTC). eMBB service provides greater data-bandwidth and may include Augmented Reality (AR), Virtual Reality (VR), UltraHD or 360-degree streaming video and many more. mMTC service may include NarrowBand Internet of Things (NB-IoT). URLLC service provides high reliability and low latency and may include mission-critical applications such as autonomous driving, Vehicle-to-Everything (V2X), remote diagnosis/surgery, smart energy and grid, and so on.

Each service may be associated with particular service characteristics, such as packet delay budget, packet error rate, maximum data burst volume, priority level, reliability requirement, allowed retransmission delay, etc. For example, the Packet Delay Budget defines an upper bound for the time that a packet may be delayed between the UE and the network (e.g., the User Plane Function (UPF)). Different services may have different characteristics and different QoS requirements. For example, a URLLC service may have strict low latency requirement and may only tolerate minimal packet delays, while it may not need a high bandwidth. On the other hand, for an eMBB service, a higher bandwidth may be needed, but it may not be as sensitive to packet delay.

Under CDRX, a UE may be provisioned with one or more connected state DRX configuration. Each connected state DRX configuration may include at least one of following parameters:
DRX downlink retransmission timer (drx-RetransmissionTimerDL): the the maximum duration until a DL retransmission is received. Each downlink Hybrid Automatic Repeat reQuest (HARQ) process (except for the broadcast process) may correspond to a drx-RetransmissionTimerDL;
DRX uplink retransmission timer (drx-RetransmissionTimerUL): the maximum duration until a grant for UL retransmission is received. Each uplink HARQ process may correspond to a drx-RetransmissionTimerUL;
DRX downlink HARQ Round Trip Time (RTT) timer (drx-HARQ-RTT-TimerDL): the minimum waiting time that the UE expects to receive the PDCCH indicating the downlink scheduling. Each downlink HARQ process (except for the broadcast process) may correspond to one drx-HARQ-RTT-TimerDL;
DRX Uplink HARQ RTT timer (drx-HARQ-RTT-TimerUL): The minimum waiting time that the UE expects to receive the PDCCH indicating uplink scheduling. Each uplink HARQ process may correspond to a drx-HARQ-RTT-TimerUL.

These parameters may impact allowed retransmission delay of a UE service and the time that UE enters into CDRX off duration. In a wireless network a UE may support different services/sessions, such as different Protocol Data Unit (PDU) sessions, different QoS flows, etc. These services may be mapped to different resources based on service requirement. For example, these services may be mapped to:
different Data Radio Bearers (DRBs);
different Logical Channels (LCs);
different resources allocated by Semi-Persistent Scheduling (SPS); or
different resources allocated by Configured Grant (CG).

The above configurations/resources (DRB, LC, SPS, and CG) may use independent HARQ processes.

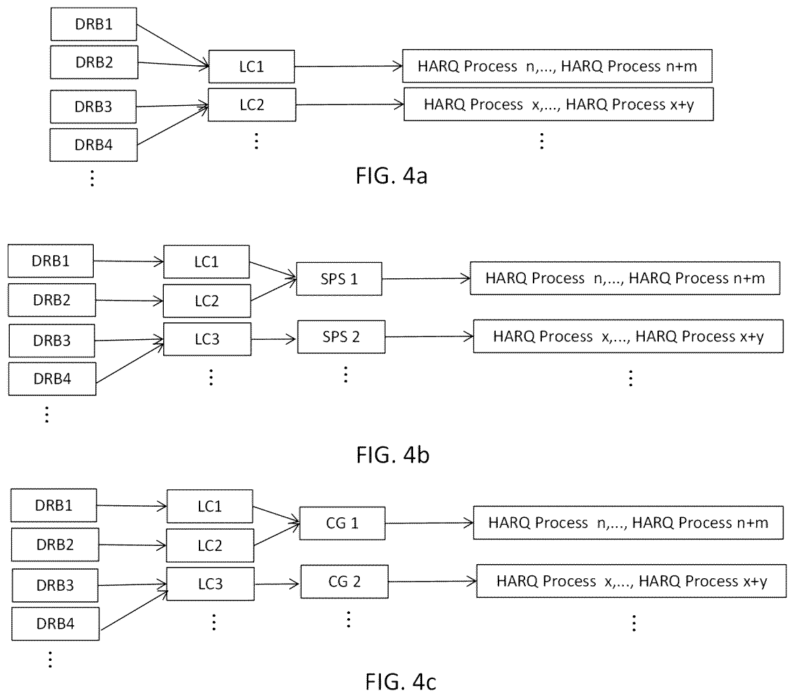

FIG. 4a illustrates an example resource to HARQ process mapping. As shown in FIG. 4a, DRB1 and DRB2 are mapped to LC1, and LC1 are configured with HARQ process n to HARQ process (n+m), with n and m being non-negative integers.

FIG. 4b illustrates another example resource to HARQ process mapping. As shown in FIG. 4b, one or more DRBs may be mapped to a LC, one or more LCs may be configured with one SPS resource, and one SPS resource may be configured with one or more HARQ processes.

FIG. 4c illustrates another example resource to HARQ process mapping. As shown in FIG. 4c, one or more DRBs may be mapped to a LC, one or more LCs may be configured with one CG resource, and one CG resource may be configured with one or more HARQ processes.

The connected state DRX timers included in a connected state DRX configuration as described above (e.g., drx-RetransmissionTimerDL, drx-RetransmissionTimerUL, drx-HARQ-RTT-TimerDL, and drx-HARQ-RTT-TimerUL) may be started or stopped per HARQ process. That is, each HARQ process may have its own set of timers.

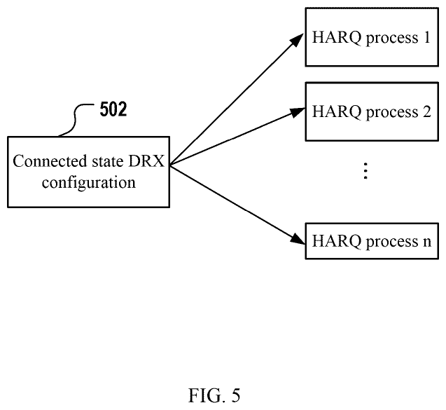

In some example implementations, a “fits all” connected state DRX configuration is applied to all HARQ processes (and all UE services). As shown in FIG. 5, a common connected state DRX configuration 502 applies to multiple HARQ processes (or resources allocated for multiple services). The “fits all” connected state DRX configuration may be at, for example, a cell level, or a DRX group level, in which the connected state DRX configuration applies to all the HARQ processes in the cell or in the cell group. Therefore, the precision (or target level) of the connected state DRX configuration is at a cell level, or a DRX group level.

In some example implementations, rather than using a “fits all” connected state DRX configuration that applies to all types of services, each service may be configured with a connected state DRX configuration. That is, the precision (or target level) of the connected state DRX configuration is raised to service level, or one or more of following levels: a DRB level, a LC level, a SPS level, a CG level, or a HARQ process level.

As described earlier, the connected state DRX configuration may include at least one of the following parameters:
drx-RetransmissionTimerDL;
drx-RetransmissionTimerUL;
drx-HARQ-RTT-TimerDL; or
drx-HARQ-RTT-TimerUL.

In this embodiment, the connected state DRX configuration may be configured to a UE at various levels and have different precisions.

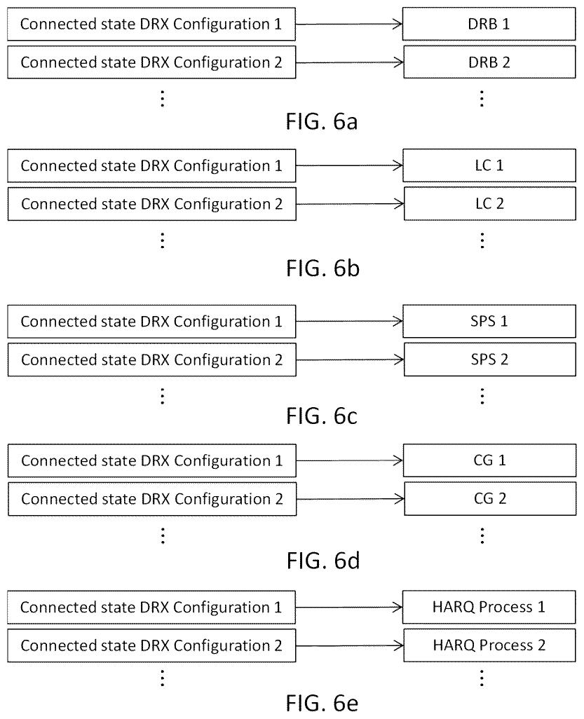

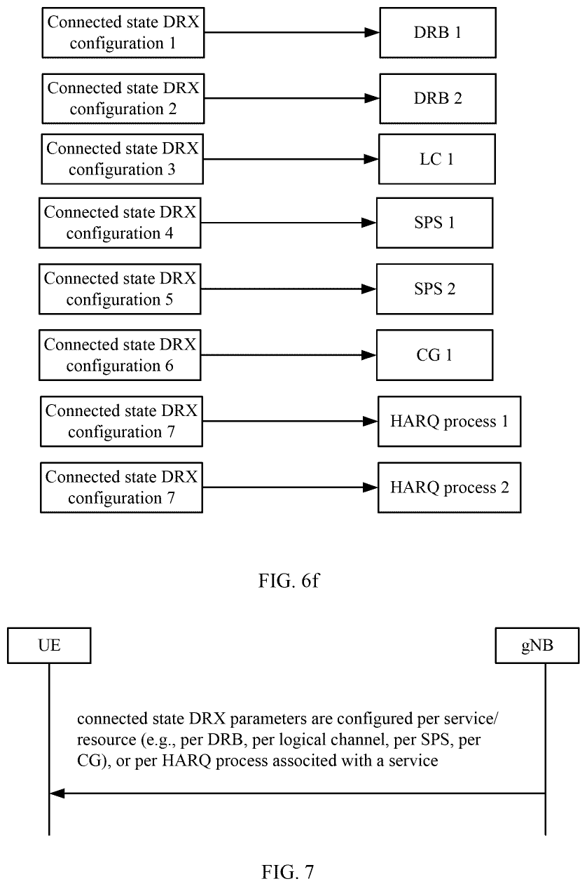

In some example implementations, a connected state DRX configuration may be configured per DRB. As shown in FIG. 6a, different DRBs may be configured with different connected state DRX configurations.

In some example implementations, a connected state DRX configuration may be configured per LC. As shown in FIG. 6b, different LCs may be configured with different connected state DRX configurations.

In some example implementations, a connected state DRX configuration may be configured per SPS (i.e., service using resource allocated by the SPS). As shown in FIG. 6c, different SPSs may be configured with different connected state DRX configurations.

In some example implementations, a connected state DRX configuration may be configured per CG (i.e., service using resource allocated by the CG). As shown in FIG. 6d, different CGs may be configured with different connected state DRX configurations.

In some example implementations, a connected state DRX configuration may be configured per HARQ process, as shown in FIG. 6e, different HARQ processes may be configured with different connected state DRX configurations.

FIG. 6f shows another example of connected state DRX configuration assignment.

FIG. 7 further shows sample message flow for the base station to configure the connected state DRX configuration to the UE, and the connected state DRX configuration is on a per service/resource basis, or on a per HARQ process basis.

In some example implementations, the connected state DRX configurations may be preconfigured to the UE by the network (e.g., a base station in the network) via, for example, messages at various layers (e.g., layer 3, layer 2, and layer 1), such as a Radio Resource Control (RRC) message, a Medium Access Control-Control Element (MAC CE) message, a Downlink Control Information (DCI) message, a system information message, a broadcast message, etc. For example, a UE may receive a system information message which carries a list of connected state DRX configurations.

In some implementations, the UE may receive an indicator which indicates which particular connected state DRX configuration from the list of connected state DRX configurations is to be selected for a particular service (e.g., a DRB, an LC, an SPS, a CG, or a HARQ process which the service is mapped to). The indicator may be, for example, an index of the list of connected state DRX configurations. The UE may then apply the selected connected state DRX configuration for the particular target (e.g., DRB, LC, SPS resource, CG resource, HARQ process). In this scenario, each service is assigned a connected state DRX configuration individually (or, the connected state DRX configuration assignment is made to each target individually).

In some implementations, the UE may receive the connected state DRX configuration and an indication indicating which target the configuration applies to.

In some implementations, it is possible to combine multiple assignment in one single message. For example, referring back to FIG. 6a, a single message may carry indicator(s) indicating that connected state DRX configuration 1 is assigned to DRB 1, and connected state DRX configuration 2 is assigned to DRB 2. Note that the assignment of the configurations is for each target (e.g., DRB, LC, SPS resource, CG resource, or HARQ process).

In some implementations, it is possible to combine multiple assignment in one single message, and one connected state DRX configuration may be assigned to multiple targets. For example, one connected state DRX configuration may be assigned to a group of DRBs, a group of LCs, a group of HARQ processes, etc.

In some implementations, it is possible for multiple services using a same connected state DRX configuration. For example, one group of DRBs may use connected state DRX configuration 1, and another group of DRBs may use connected state DRX configuration 2, yet another group of HARQ processes may use connected state DRX configuration 3. Note that in this case, connected state DRX configurations 1, 2, and 3 are not “fits all” connected state DRX configuration, even each of them may apply to multiple services. Exemplarily, for each service, the network may still need to individually indicate which connected state DRX configuration to use.

In some example implementations, a UE may still be configured with a “fits all” connected state DRX configuration, such as a cell level, or a DRX group level connected state DRX configuration. The “fits all” connected state DRX configuration may serve as a default configuration. In this case, service specific connected state DRX configuration has higher priority, if configured. That is, if a service specific connected state DRX configuration is configured for a DRB, a LC, a SPS, a CG, or a HARQ process, the then service specific connected state DRX configuration is applied to, for example, the DRB, the LC, the SPS, the CG, or the HARQ process. Otherwise, the cell level, or the DRX group level connected state DRX configuration may be applied.

In this embodiment, a connected state DRX configuration is specific to a service (or a target such as a resource or a HARQ process), rather than “fits all”. For each service, the network is able to designate a connected state DRX configuration. Therefore, the network may gain precise control over transmission characteristics for a service based on, for example, a service requirement, such as a QoS requirement. The connected state DRX configuration provided in this embodiment has a higher precision compared to a “fits all” configuration.

### Embodiment 2: HARQ Mode Configuration in Terrestrial Network

In a Non-Terrestrial Network (NTN), different HARQ modes, including HARQ mode A and HARQ mode B, may be supported, which aims to improve the UE data rate in large RTT (Round-Trip Time) use case, and avoid the HARQ stalling. In HARQ mode A, HARQ RTT timer and a retransmission timer may be started (e.g., retransmission is activated). However, in HARQ mode B, HARQ RTT timer and retransmission timer are not started. For example, for a UE in NTN, if a HARQ process is configured with HARQ mode B, then the UE is not expected to start a HARQ RTT timer and/or a retransmission timer.

In some example implementations, in an NTN, the base station, based on service characteristics of a service (e.g., service type, QoS requirement, service pattern, etc.), is able to indicate to UE whether to start a HARQ RTT timer and/or a retransmission timer for a HARQ process associated with the service.

In a Terrestrial Network (TN) environment, however, HARQ modes as described above for the NTN network are not supported. Although employing HARQ modes may still be beneficial in the TN network. For example, UE may carry services with small periodicity (e.g. with a 4 milli second periodicity), and power saving is critical for the UE (e.g. CG and/or CDRX may be configured/activated for the UE). In this case, if the HARQ RTT Timer and re-transmission timer are started, it will be difficult or even impossible for the UE to enter CDRX off state for power saving. On the other hand, for the service with small periodicity, the retransmission may still be performed on the next CG occasion or scheduling grant, if necessary. Thus, the HARQ timer and the retransmission timer are not necessary to be started, which can improve the UE power saving.

In this embodiment, the aforementioned HARQ modes may be added in the TN network. However, a UE may or may not have the capability to support this feature. For example, a legacy UE, or a low-end UE may not support this feature. This may cause some issues on a base station side. As the base station does not know UE's capability with respect to the support of HARQ modes, the base station may not take advantage of its knowledge on the service characteristics of a UE service. For example, in this case, the base station cannot instruct the UE not to start the HARQ RTT timer and/or the retransmission timer for a HARQ process anyway, even the base station knows it is beneficial not to start the HARQ RTT timer and/or the retransmission timer for a HARQ process. This behavior may further have a negative impact with respect to UE power consumption due to having to start a timer unconditionally.

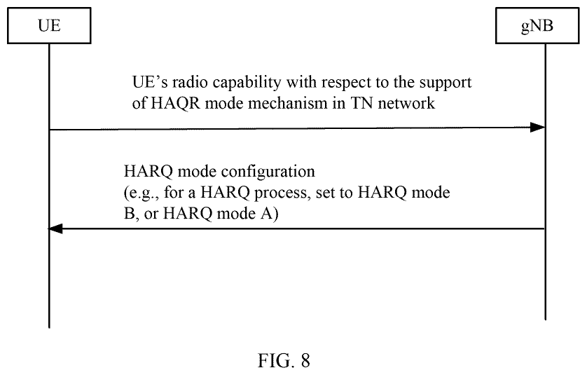

In this embodiment, when a UE is in a TN, it may report its UE capability with respect to the support of HARQ modes to the base station. For example, UE may report whether it supports the HARQ mode mechanism as described above (or whether it supports HARQ mode B). Only when the UE supports HARQ mode mechanism in TN, the base station may configure the HARQ mode (e.g., HARQ mode A or HARQ mode B) to the UE, when the UE is served by a terrestrial network cell. An exemplary process is illustrated in FIG. 8.

As shown in FIG. 8, the UE capability may be sent in a Radio Resource Control (RRC) message, such as an RRC Msg3/Msg5 (e.g., as seen in a random access procedure, and/or an RRC connection setup procedure), a UECapabilityInformation message, an uplink Medium Access Control—Control Element (UL MAC CE) message. Alternatively, the UE capability may be implicitly indicated by UL LC_ID (Logical Channel ID) in a MAC CE header.

In some implementations, the HARQ mode configuration applies to uplink HARQ mode (uplinkHARQ-Mode), when the UE is in a TN cell (or served by a TN cell)

The HARQ mode configuration may be set by, for example, uplinkHARQ-Mode in an RRC message for the UE in TN cell. For example, the bit of uplinkHARQ-Mode for the HARQ process may be set to HARQ-Mode B.

Table 1 below shows example logic flow for starting relevant HARQ RTT timers in NTN and NT network. In Table 1, if the name of a timer is ended with “-NTN”, it indicates the timer applies to NTN network; otherwise, the time applies to TN network.

TABLE 1

| > | if a MAC PDU is transmitted in a configured | |
|---|---|---|
| | uplink grant and LBT failure indication is not | |
| | received from lower layers: | |
| | 2> | if this Serving Cell is configured with |
| | | uplinkHARQ-Mode and the cell is a non-terrestrial |
| | | network cell |

| | |
|---|---|
| 3> | if the corresponding HARQ process is |
| | configured as HARQModeA: |

| | |
|---|---|
| 4> | set HARQ-RTT-TimerUL-NTN for the |
| | corresponding HARQ process equal to drx- |
| | HARQ-RTT-TimerUL plus the latest available |
| | UE-gNB RTT value; |
| 4> | if drx-LastTransmissionUL is configured: |

| | |
|---|---|
| 5> | start the HARQ-RTT-TimerUL-NTN for |
| | the corresponding HARQ process in the |
| | first symbol after the end of the last |
| | transmission (within a bundle) of the |
| | corresponding PUSCH transmission. |

| | |
|---|---|
| 4> | else: |

| | |
|---|---|
| 5> | start the HARQ-RTT-TimerUL-NTN for |
| | the corresponding HARQ process in the |
| | first symbol after the end of the first |
| | transmission (within a bundle) of the |
| | corresponding PUSCH transmission. |

| | |
|---|---|
| 2> | else: |

| | |
|---|---|
| 3> | if this Serving Cell is not configured |
| | with uplinkHARQ-Mode, or |
| 3> | if this Serving Cell is configured with |
| | uplinkHARQ-Mode, the corresponding HARQ |
| | process is configured as HARQModeA and |
| | the cell is a terrestrial network cell |

| 4> | | if drx-LastTransmissionUL is configured: |
|---|---|---|
| | 5> | start the drx-HARQ-RTT-TimerUL for |
| | | the corresponding HARQ process in the |
| | first symbol after the end of the last | |
| | transmission (within a bundle) of the | |
| | corresponding PUSCH transmission. | |
| 4> | | else: |
| | 6> | start the drx-HARQ-RTT-TimerUL for |
| | | the corresponding HARQ process in the |

first symbol after the end of the first
transmission (within a bundle) of the
corresponding PUSCH transmission.

### Embodiment 3: HARQ Timer Deactivating Indicator

In this embodiment, the indication for deactivating (or not staring) a drx-HARQ-RTT-Timer may be configured per UE, per DRB, per logical channel, per SPS, per CG, and/or per HARQ process. The drx-HARQ-RTT-Timer may include drx-HARQ-RTT-TimerDL, and drx-HARQ-RTT-TimerUL, as described earlier. When a timer is deactivated, the UE is not expected to start the timer.

In example implementations, the base station (e.g., the gNB), based on service characteristics of a service associated with one of: a DRB, a logical channel, an SPS, a CG, or a HARQ process, may decide to deactivate the drx-HARQ-RTT-Timer (for DL and/or UL) by using an indicator specific to the service.

Specifically, if the indication for deactivating the drx-HARQ-RTT-Timer is configured per UE, per DRB, per logical channel, per SPS, per CG, and/or per HARQ process, the UE will not or is not expected to start the drx-HARQ-RTT-Timer when sending or receiving data for the DRB, for the logical channel, for the SPS, for the CG, and/or for the HARQ process accordingly. That is, the precision (or target level) for deactivating the drx-HARQ-RTT-Timer is raised to one or more of following levels: a UE level, a DRB level, a LC level, a SPS level, a CG level, or a HARQ process level.

The indication for deactivating the drx-HARQ-RTT-Timer (UL and DL) may be configured by an RRC message, a MAC CE message, or a DCI message.

The indication for deactivating the drx-HARQ-RTT-Timer may also be carried via an HARQ Feedback Disabled indicator, e.g., to disable the HARQ Feedback. When the HARQ Feedback is disabled, the drx-HARQ-RTT-Timer may be deactivated.

In some example implementations, a UE may or may not support the feature of DRX HARQ RTT timer deactivation, or a UE may or may not support the feature of DRX HARQ feedback deactivation. In this case, the UE may send an indicator to the base station, the indicator indicating a radio capability of the UE. The radio capability is indicative of whether the UE supports the DRX HARQ RTT timer deactivation feature or whether the UE supports the HARQ feedback deactivation feature. Based on the indicator, a base station may decide whether it is allowed to deactivate the DRX HARQ RTT timer for the UE, or deactivate the HARQ feedback.

### Embodiment 4: Cell DTX/DRX Activation Indication

As described in above sections, cell DTX and/or cell DRX may be employed to save network energy consumption (e.g., to save gNB energy). The cell DTX/DRX feature may be activated or deactivated based on, for example, cell load, or other traffic patterns that may impact cell signal transmission and/or reception. The cell load may include cell load measured in real time, or cell load predicted based on historical data via, for example, an Artificial Intelligence (AI) model. The cell DTX/DRX feature may be activated when there is no traffic in the cell, or the cell load is light (e.g., below a threshold, below an occupancy ratio, etc.), and deactivated when the cell is in heavy load (e.g., above a threshold, above an occupancy ratio, etc.). Furthermore, as the cell load is a fluctuating factor, the cell DTX/DRX may be activated/deactivated as needed, and the corresponding cell DTX/DRX configuration (e.g., periodicity, start time and/or start offset, etc., which are used to decide the DTX/DRX “ON” period and “OFF” period) may also be updated dynamically. As an example, when the cell load is in a first range, cell DTX/DRX configuration 1 may be configured; when the cell load is in a second range, cell DTX/DRX configuration 2 may be configured.

In some example implementations, the cell DTX and/or cell DRX mechanism is a 2-step process. In the first step, the cell DTX and/or cell DRX configuration may be pre-configured to the UE when UE's RRC connection is setup or re-configured. In the second step, when the condition to activate cell DTX and/or cell DRX feature is met (e.g., based on cell load condition), the base station may activate the cell DTX and/or cell DRX feature via, for example, a layer 1 common signaling, such as a DCI message. Note that this common signaling may target all the UEs in RRC connected (RRC_CONNECTED) state and covered/served by the cell.

Note that in the above implementation, the common signaling is sent to UEs in RRC connected state when the cell DTX and/or cell DRX configuration is initially configured in the cell. However, for UEs not in RRC connected state (e.g., UEs in idle, or inactive state), these UEs may miss the common signaling for activating the DTX and/or cell DRX feature.

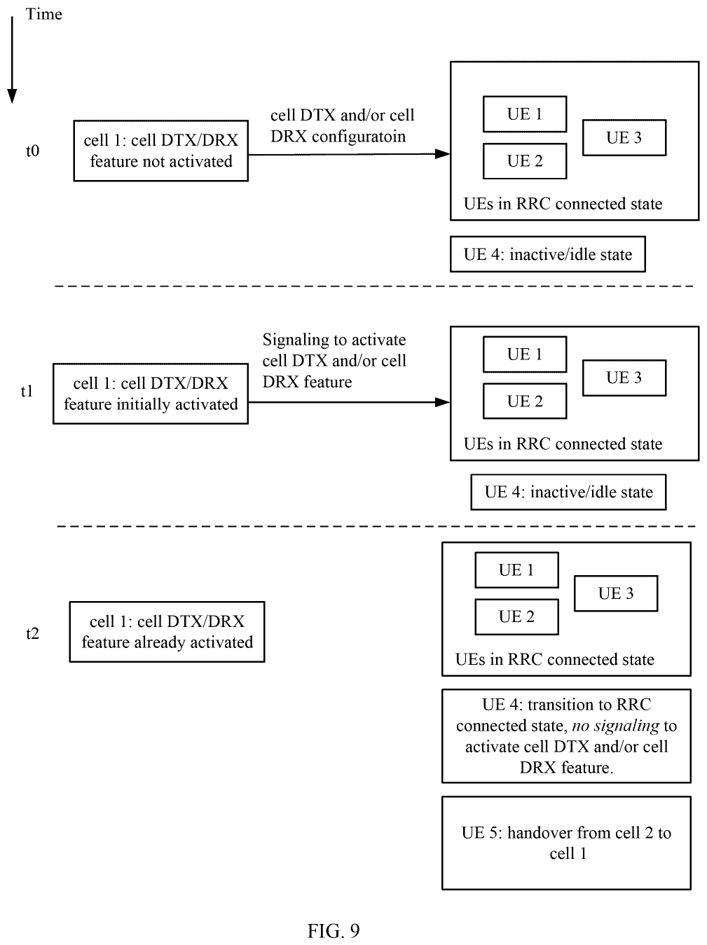

FIG. 9 shows an example scenario as described above:

At t0, all the UEs in RRC connected state may receive cell DTX and/or cell DRX configuration. The configuration is not activated yet. Note that UE 4 is in an inactive or idle state.

At t1, it is determined that the cell DTX and/or cell DRX feature needs to be activated. A common signaling is sent to all the UEs in RRC connected state, indicating the feature activation.

At t2, UE 4 transitions to RRC connected state. Note that UE 4 missed the signaling sent at t1, and is not aware of and will not apply the cell DTX and/or cell DRX feature activation.

Similarly, the issue described above may also happen during a UE handover procedure. Still referring to FIG. 9, at t2, UE 5 is handed over from cell 2 to cell 1. As the handover happens after the initial cell DTX and/or cell DRX feature activation happened at t1, UE 5 is not aware of and will not apply the cell DTX and/or cell DRX feature activation.

In this disclosure, various solutions are described below, to solve the above-mentioned issue.

### Solution 1:

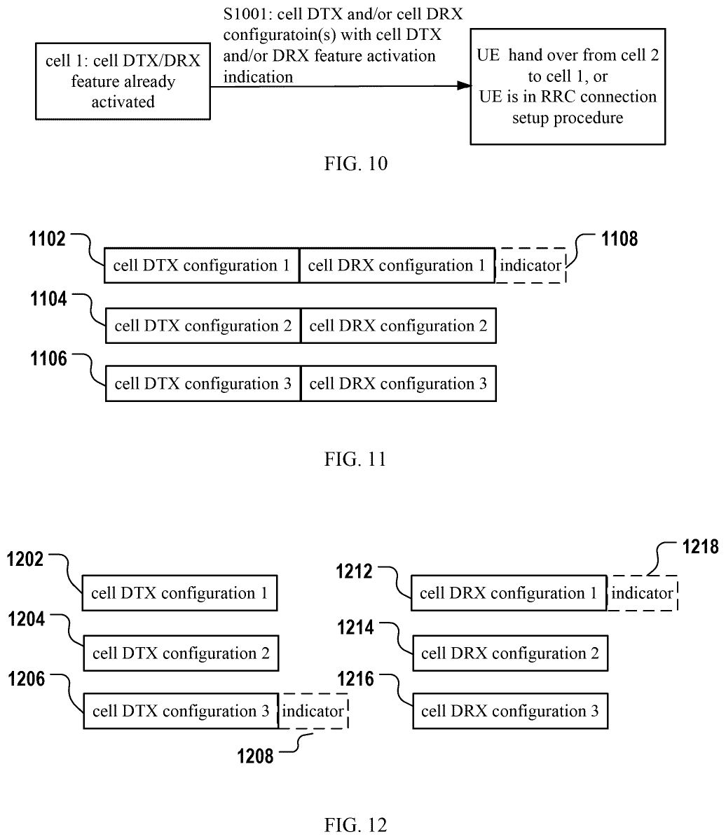

Referring to FIG. 10, when UE is handed over to cell 1 with cell DTX activated and/or cell DRX already activated, or if the UE is in an RRC connection setup procedure (UE is in inactive or idle state when the cell DTX and/or the cell DRX feature is initially activated), the UE may receive cell DTX and/or cell DRX configuration(s), as shown in FIG. 10, step S1001. For example, UE may receive one or more cell DTX and/or cell DRX configurations (e.g., a list of configurations). An indicator may be sent together with the configurations, or via another message. The indicator may indicate that the cell DTX and/or the cell DRX feature is activated, or which configuration needs to be applied and activated. Once UE receives this indicator, it will activate the cell DTX and/or cell DRX feature immediately, using the indicated configuration.

In some example implementations, the list of configurations may include configuration for both cell DTX configuration and cell DRX configuration.

In some example implementations, there may be two lists, with one list for cell DTX configuration, and the other list for cell DRX configuration. Correspondingly, there may be two indicators, one for indicating the cell DTX configuration, and the other for indicating the cell DRX configuration. This way, the cell DTX and cell DRX feature may be separately activated. The underlying principle is that the indication(s) may be sent to the UE, to indicate which feature(s) (i.e., cell DTX and/or cell DRX) is to be activated using an indicated configuration.

In case the UE is handed over to cell 1 with cell DTX and/or cell DRX feature deactivated, the indicator will make the indication correspondingly, so the UE will not activate the cell DTX and/or the cell DRX feature right after the handover. If later on, the cell DRX and cell DTX feature are activated, a layer 1 common signaling may be sent to the UE for indicating the feature activation.

In some example implementations, the indicator may be mandatory. Exemplarily, a value 1 may indicate feature activation, and a value 0 may indicate that the feature is not activated.

In some example implementations, the indicator may be optional. When the indicator present, it indicates that the feature is activated, whereas if the indicator is absent, it indicates that the feature is not activated.

FIG. 11 shows example cell DTX/DRX configurations. In FIG. 11, cell DTX configuration and cell DRX configuration can be sent combined. FIG. 11 shows 3 combined configurations 1102, 1104, and 1106. To indicate a combination, an indicator 1108 may be attached to the selected configuration. Alternatively, an index may be sent to indicate which element in the list of configurations is selected. For example, an indicator equals to 2 indicate (cell DTX configuration 2+ cell DRX configuration 2).

Note that cell DTX configurations, and cell DRX configurations may be sent separately, as shown in FIG. 12. Cell DTX configurations 1202, 1204, and 1206, and cell DRX configurations 1212, 1214, and 1216 may be sent to the UE. Indicator 1208 may be used to indicate a cell DTX configuration to be activated, and another indicator 1218 may be used to indicate a cell DRX configuration to be activated.

In some example implementations, step S1001 may happen during the handover procedure or the RRC connection setup procedure. For example, UE may receive the message in S1001 from cell 2, which is the source cell in the handover procedure. That is, the cell DTX and/or cell DRX configurations, and/or the feature activation indicator, may be sent by the source cell. The benefit may include a quick feature activation—as the feature activation is part of the handover procedure, or the RRC connection setup procedure. Once the UE is handed over, or once the UE RRC connection is setup, the cell DTX and/or the cell DRX feature is already activated using the indicated configuration.

### Solution 2:

In this solution, both layer 1 common signaling (e.g., common DCI) and UE specific signaling (e.g., MAC CE, or UE specific DCI, or dedicated RRC signaling) may be used to activate the cell DTX and/or cell DRX feature.

When the cell DTX and/or cell DRX is activated initially, a layer 1 common signaling (e.g. common DCI) may be sent to UEs in RRC connected (RRC_CONNECTED) state for cell DTX and/or cell DRX activation.

When the cell DTX and/or cell DRX has already activated for the cell, and a UE is handed over to the cell, if the UE is in an RRC connection setup procedure, to setup an RRC connection with the cell, a UE specific signaling (e.g., MAC CE, or UE specific DCI, or dedicated RRC signaling) may be sent to the UE for cell DTX and/or cell DRX activation. The indicator may be implemented similarly as provided in solution 1 above.

In some example implementations, a UE may or may not support the feature of cell DTX operation and/or cell DRX operation. In this case, the UE may send an indicator to the base station, the indicator indicating a radio capability of the UE. The radio capability is indicative of whether the UE supports the Cell DTX operation and/or cell DRX operation. Based on the indicator, a base station may decide whether it is allowed to configure and/or activate the cell DTX operation and/or the cell DRX operation for the UE.

The description and accompanying drawings above provide specific example embodiments and implementations. The described subject matter may, however, be embodied in a variety of different forms and, therefore, covered or claimed subject matter is intended to be construed as not being limited to any example embodiments set forth herein. A reasonably broad scope for claimed or covered subject matter is intended. Among other things, for example, subject matter may be embodied as methods, devices, components, systems, or non-transitory computer-readable media for storing computer codes. Accordingly, embodiments may, for example, take the form of hardware, software, firmware, storage media or any combination thereof. For example, the method embodiments described above may be implemented by components, devices, or systems including memory and processors by executing computer codes stored in the memory.

Throughout the specification and claims, terms may have nuanced meanings suggested or implied in context beyond an explicitly stated meaning. Likewise, the phrase “in one embodiment/implementation” as used herein does not necessarily refer to the same embodiment and the phrase “in another embodiment/implementation” as used herein does not necessarily refer to a different embodiment. It is intended, for example, that claimed subject matter includes combinations of example embodiments in whole or in part.

In general, terminology may be understood at least in part from usage in context. For example, terms, such as “and”, “or”, or “and/or,” as used herein may include a variety of meanings that may depend at least in part on the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” may be understood to convey a singular usage or to convey a plural usage, depending at least in part upon context. In addition, the term “based on” may be understood as not necessarily intended to convey an exclusive set of factors and may, instead, allow for the existence of additional factors not necessarily expressly described, again, depending at least in part on context.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution may be practiced without one or more of the specific features or advantages of a particular embodiment. In other instances, additional features and advantages may be recognized in certain embodiments that may not be present in all embodiments of the present solution.

1.-18. (canceled)

19. A method for wireless communication, performed by a wireless device, comprising:
receiving, via a UE specific message targeting the wireless device, an indicator indicating whether a cell discontinuous operation is activated in a cell, wherein the cell discontinuous operation comprising at least one of a cell Discontinuous Transmission (DTX) or a cell Discontinuous Reception (DRX); and
in response to the indicator indicating the cell discontinuous operation being activated in the cell, activating a configuration associated with the cell discontinuous operation.

20. The method of claim 19, wherein before receiving the UE specific message targeting the wireless device, the method further comprising:
transmitting, to a network node, an indicator indicating a radio capability of the wireless device, the radio capability being indicative of whether the wireless device supports at least one of the cell DTX or the cell DRX operation.

21. The method of claim 19, wherein the UE specific message comprises an RRC message.

22. The method of claim 19, wherein receiving the indicator indicating whether the cell discontinuous operation is activated in the cell comprises:
receiving the indicator together with a configuration associated with the cell discontinuous operation.

23. The method of claim 19, wherein:
receiving the indicator indicating whether the cell discontinuous operation is activated in the cell comprises:
receiving, via the UE specific message targeting the wireless device, a list of candidate configurations for cell discontinuous operation, and the indicator indicating whether a configuration in the list of candidate configurations is activated; and
activating the configuration associated with the cell discontinuous operation comprises:
in response to the indicator indicating the configuration in the list of candidate configurations being activated, activating the configuration.

24. The method of claim 19, wherein the configuration associated with the cell discontinuous operation comprises at least one of the following parameters:
a cell DTX periodicity parameter for deciding a cell DTX “ON” period and a cell DTX “OFF” period;
a cell DTX start offset parameter for deciding the cell DTX “ON” period and the cell DTX “OFF” period;
a cell DRX periodicity parameter for deciding a cell DRX “ON” period and a cell DRX “OFF” period; or
a cell DRX start offset parameter for deciding the cell DRX “ON” period and the cell DRX “OFF” period.

25. The method of claim 19, wherein activating the configuration associated with the cell discontinuous operation comprises disabling at least one of:
receiving a downlink signal or a downlink channel during a cell DTX OFF period; or
transmitting an uplink signal or an uplink channel during a cell DRX OFF period.

26.-43. (canceled)

44. A method for wireless communication, performed by a network node, comprising:
transmitting, via a UE specific message targeting a wireless device, an indicator indicating whether a cell discontinuous operation is activated in a cell of the network node, wherein the cell discontinuous operation comprising at least one of a cell Discontinuous Transmission (DTX) or a cell Discontinuous Reception (DRX).

45. The method of claim 44, wherein before transmitting the UE specific message targeting the wireless device, the method further comprising:
receiving, from the wireless device, an indicator indicating a radio capability of the wireless device, the radio capability being indicative of whether the wireless device supports at least one of the cell DTX or the cell DRX operation.

46. The method of claim 44, wherein in response to transmitting the indicator indicating the cell discontinuous operation being activated in the cell, the method further comprises activating a configuration associated with the cell discontinuous operation.

47. The method of claim 46, wherein the configuration associated with the cell discontinuous operation comprises at least one of the following parameters:
a cell DTX periodicity parameter for deciding a cell DTX “ON” period and a cell DTX “OFF” period;
a cell DTX start offset parameter for deciding the cell DTX “ON” period and the cell DTX “OFF” period;
a cell DRX periodicity parameter for deciding a cell DRX “ON” period and a cell DRX “OFF” period; or
a cell DRX start offset parameter for deciding the cell DRX “ON” period and the cell DRX “OFF” period.

48. The method of claim 44, wherein the UE specific message comprises an RRC message.

49. The method of claim 44, wherein transmitting the indicator indicating whether the cell discontinuous operation is activated in the cell comprises:
transmitting the indicator together with a configuration associated with the cell discontinuous operation.

50. The method of claim 44, wherein:
transmitting the indicator indicating whether the cell discontinuous operation is activated in the cell comprises:
transmitting, via the UE specific message targeting the wireless device, a list of candidate configurations for cell discontinuous operation, and the indicator indicating whether a configuration in the list of candidate configurations is activated.

51. The method of claim 44, wherein:
the indicator indicating that the cell discontinuous operation is activated in the cell of the network node; and
the method further comprises disabling at least one of:
transmitting a downlink signal or a downlink channel during a cell DTX OFF period; or
receiving an uplink signal or an uplink channel during a cell DRX OFF period.

52. A device for wireless communication comprising a memory for storing computer instructions and a processor in communication with the memory, wherein, when the processor executes the computer instructions, the processor is configured to implement a method of claim 44.

53. A computer program product comprising a non-transitory computer-readable program medium with computer code stored thereupon, the computer code, when executed by one or more processors, causing the one or more processors to implement a method of claim 44.

54. A device for wireless communication comprising a memory for storing computer instructions and a processor in communication with the memory, wherein, when the processor executes the computer instructions, the processor is configured to implement a method of claim 19.

55. A computer program product comprising a non-transitory computer-readable program medium with computer code stored thereupon, the computer code, when executed by one or more processors, causing the one or more processors to implement a method of claim 19.
